(19) United States
(12) Patent Application Publication
(10) Pub. No.: US 2013/0111834 A1
(43) Pub. Date: May 9, 2013

(54) GLAZING ANCHORAGE SYSTEM

(71) Applicant: GLASTECH GLAZING CONTRACTORS LTD., Port Coquitlam (CA)

(72) Inventor: Warren ELMER, Port Coquitlam (CA)

(73) Assignee: GLASTECH GLAZING CONTRACTORS LTD., Port Coquitlam (CA)

(21) Appl. No.: 13/672,845

(22) Filed: Nov. 9, 2012

Related U.S. Application Data
(60) Provisional application No. 61/557,743, filed on Nov. 9, 2011.

(51) Int. Cl. E06B 3/58

(52) U.S. Cl. CPC E06B 3/58
USPC 52/204.591

(57) ABSTRACT

The present technology provides a glazing anchorage system for interconnecting a glazing unit with a frame of a structure. The glazing anchorage system comprises a glass anchorage connector, a frame anchorage connector and an interconnector. The interconnector is configured to couple the glass and frame anchorage connectors. The glass anchorage connector is fixedly connected to the glazing unit and includes a first elongated connection member. The frame anchorage connector is fixedly connected to the frame of the structure and includes a second elongated connection member. The interconnector is configured to couple the first elongated connection member and the second elongated connection member thus interconnecting the glass anchorage connector and the frame anchorage connector and thereby anchoring the glazing unit with the frame of a structure.

### CROSS-REFERENCE TO RELATED APPLICATIONS

This application claims the benefit and priority of U.S. Provisional Application No. 61/557,743, filed Nov. 9, 2011. The foregoing application is incorporated by reference herein in its entirety.

### FIELD OF THE INVENTION

The present invention pertains to the field of glazing and in particular to a glazing anchorage system.

### BACKGROUND

Windows comprise a glazing unit mounted within a surrounding frame. The glazing unit is typically a sealed double glazing unit comprising two parallel spaced apart panes of glass joined and sealed around their edges to enclose a space between the panes. The frame is made up from a number of sections, joined together at their ends and the corners of the frame. The frame may be made from for example, wood, aluminum, steel, fibreglass or plastic, for example unplasticized polyvinyl chloride (uPVC). The inside edge of the frame defines a rebate to receive the glazing unit within the frame with the frame surrounding the glazing unit.

In general, the space between the above glazing units is defined by the surrounding frame and thus is visible from the interior or exterior and is typically referred to as a mullion. In some prior art instances, the reduction of these mullions is desired in order to provide a desired architectural feature. FIG. 1 illustrates an example of an implementation of such a glazing mounting system. As illustrated, the glazing unit 10 is coupled to the framing system 40 associated with the structure, using for example a structural adhesive 20, for example silicone. In addition, a sealing mechanism or gasket 30 can be used on the opposite side of the glazing unit 10 to seal the glazing unit with the framing system 40. This type of glazing system is most commonly referred to as unitized curtain wall. In addition, for this type of glazing system, the panels are formed with the glazing, seals and gaskets and manufactured in a shop with a fast curing silicone. These panels are subsequently transported to a site and can be elevated into position on the building by a crane or hoist. However, a potential issue with the configuration of the glazing mounting system illustrated in FIG. 1 is the loss of connectivity between the glazing unit and the framing system associated with the structure.

Therefore there is a need for a glazing anchorage system that can overcome one or more of the problems in the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a glazing anchorage system. In accordance with an aspect of the present invention, there is provided a glazing anchorage system for interconnecting a glazing unit with a frame of a structure, the glazing anchorage system comprising: a glass anchorage connector fixedly connected to the glazing unit, the glass anchorage connector including a first elongated connection member; a frame anchorage connector fixedly connected to the frame of the structure, the frame anchorage connector including a second elongated connection member; and an interconnector configured to couple the first elongated connection member and the second elongated connection member; thereby anchoring the glazing unit to the frame of the structure.

### BRIEF DESCRIPTION OF THE FIGURES

FIG. 1 illustrates a cross sectional view of a prior art glazing mounting system.

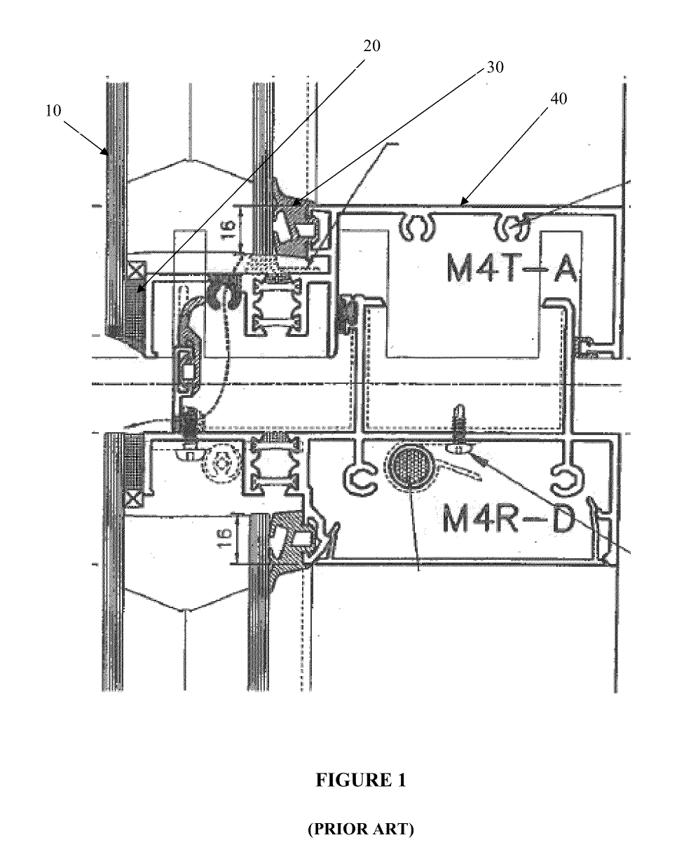

FIG. 2 illustrates a cross sectional view of a glazing mounting system including a glazing anchorage system according to embodiments of the present technology.

FIG. 3 illustrates a cross sectional view of another glazing mounting system including a glazing anchorage system according to embodiments of the present technology.

FIG. 4 illustrates a cross sectional view of a glazing mounting system including a glazing anchorage system according to embodiments of the present technology.

FIG. 5 illustrates a cross sectional view of a glazing anchorage system according to embodiments of the present technology.

FIG. 6 illustrates a cross sectional view of extrusions which are interconnected to form a glazing anchorage system according to embodiments of the present technology.

FIG. 7 illustrates an exploded cross sectional view of the extrusion illustrated in FIG. 6.

FIG. 8 illustrates a cross sectional view of a glass anchorage connector of the glazing anchorage system illustrated in FIG. 6.

FIG. 9 illustrates a cross sectional view of a frame anchorage connector of the glazing anchorage system illustrated in FIG. 6.

FIG. 10 illustrates a cross sectional view of an interconnector of the glazing anchorage system illustrated in FIG. 6.

### DETAILED DESCRIPTION

### Definitions

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a glazing anchorage system for interconnecting a glazing unit with a frame of a structure. The glazing anchorage system comprising a glass anchorage connector, a frame anchorage connector and an interconnector which is configured to couple the glass and frame anchorage connectors. The glass anchorage connector is fixedly connected to the glazing unit and includes a first elongated connection member. The frame anchorage connector is fixedly connected to the frame of the structure and includes a second elongated connection member. The interconnector is configured to couple the first elongated connection member and the second elongated connection member thus interconnecting the glass anchorage connector and the frame anchorage connector and thereby anchoring the glazing unit with the frame of a structure.

In some embodiments of the present technology, each of the glass anchorage connector, the frame anchorage connector and the interconnector are formed as elongated members, for example extrusions, having a desired cross sectional profile to enable the coupling of these components.

In some embodiments, the first finger elongated member and the second elongated member include protrusions which are configured to at least in part mate with protrusions which are formed in the interconnector. The mating of these respective protrusions can provide resistance to the decoupling of the interconnector from the first and the second elongated members.

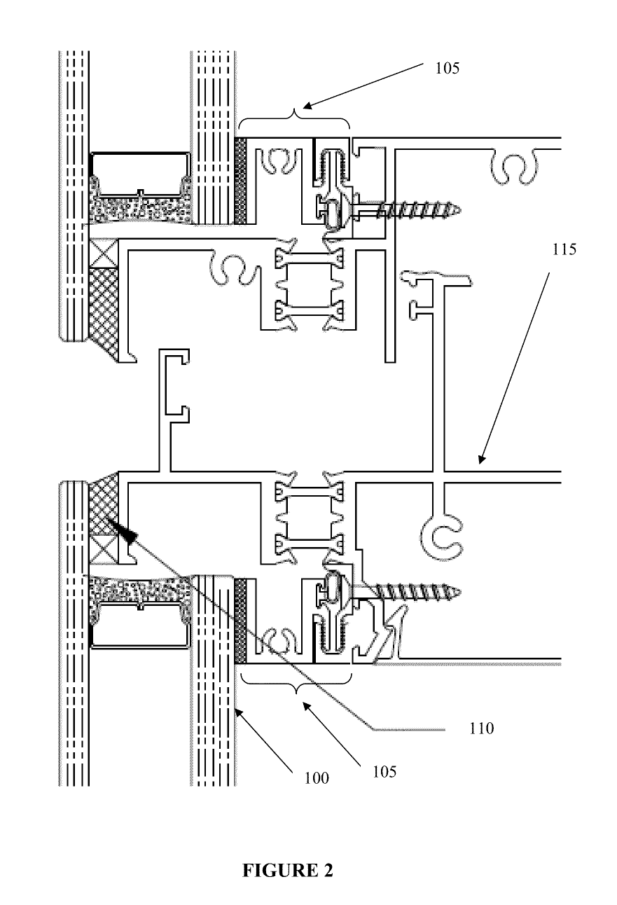

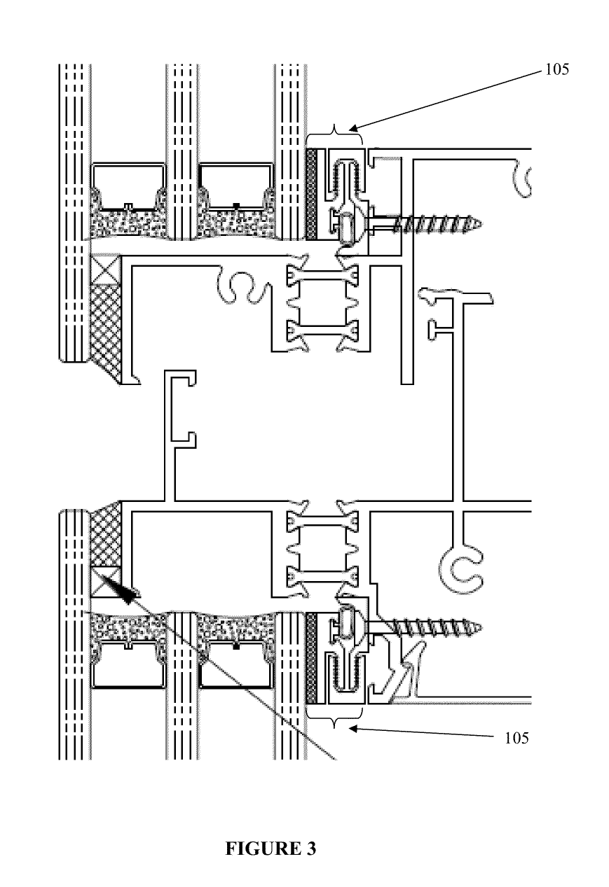

FIG. 2 illustrates a glazing mounting system which includes a glazing anchorage system in accordance with embodiments of the present technology. The glazing unit 100, which is configured as a double glazing unit, is fixedly connected to the frame 115 at a first location by a bonding element 110. The glazing mounting system further includes a glazing anchorage system 105, which is configured to couple the glazing unit 100 and the frame 115 at a second location. In the configuration illustrated in FIG. 2, there are two adjacent glazing units which are each connected to the frame of the structure using a glazing anchorage system according to embodiments of the present technology. FIG. 3 illustrates a glazing mounting system which includes a glazing anchorage system similar to that as illustrated in FIG. 2, however in this figure the glazing unit is a triple glazing unit.

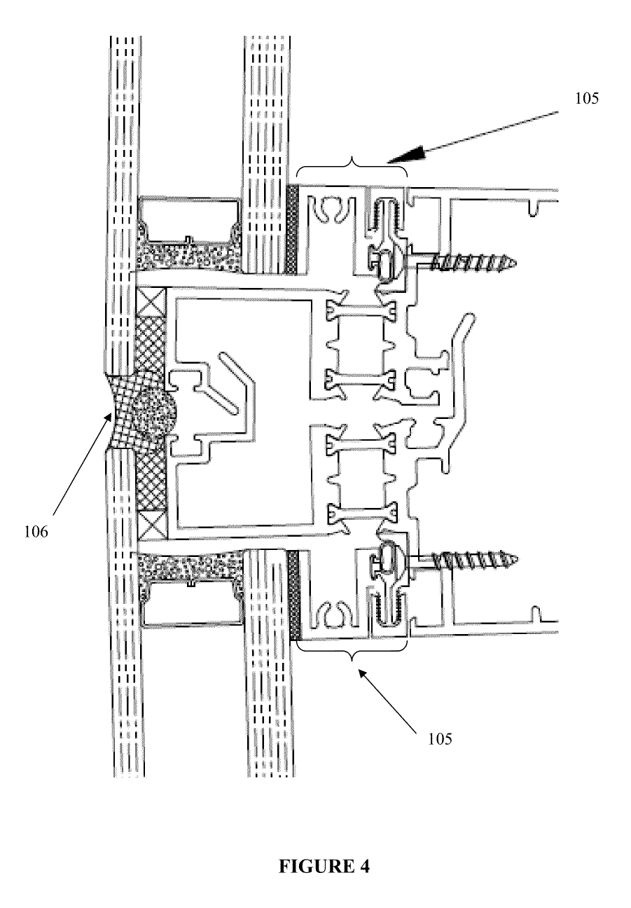

FIG. 4 illustrates another example of a glazing mounting system which includes two glazing anchorage systems in accordance with embodiments of the present technology. As illustrated in this figure, the glazing units can be further interconnected by a sealing system 106, which can provide environmental protection and optionally structural integrity, depending on the sealing system used.

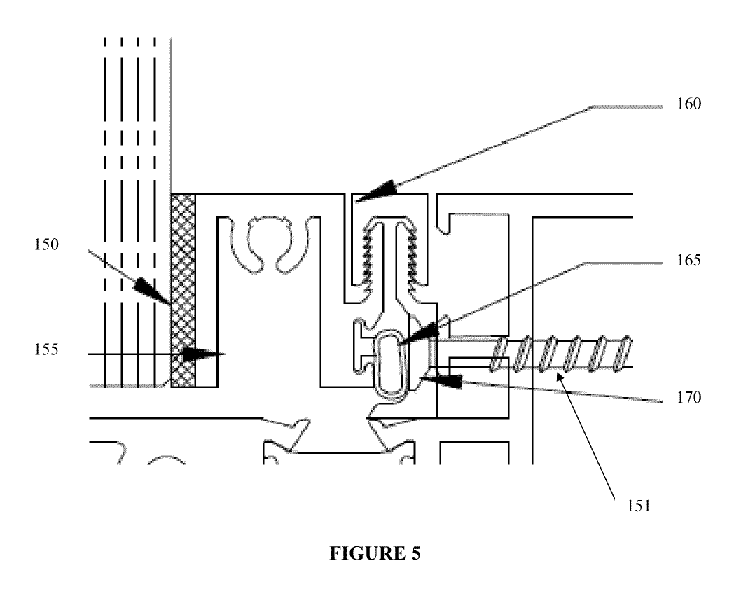

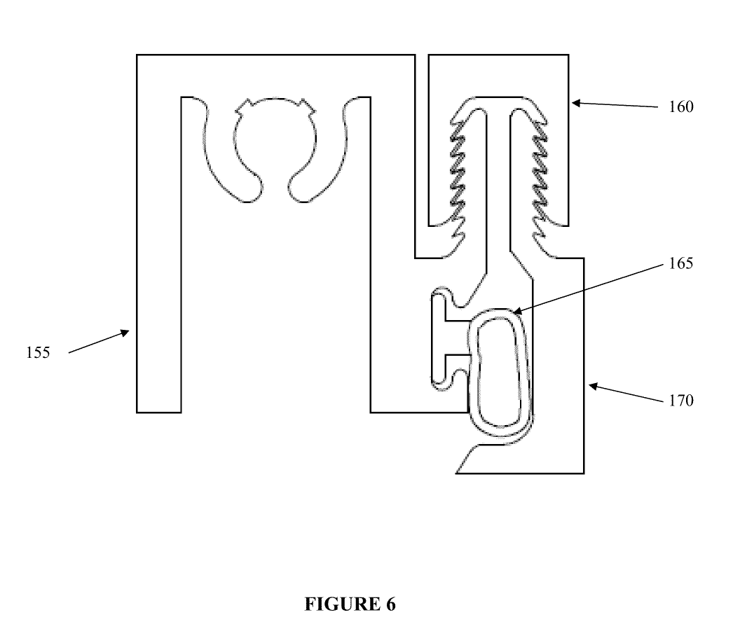

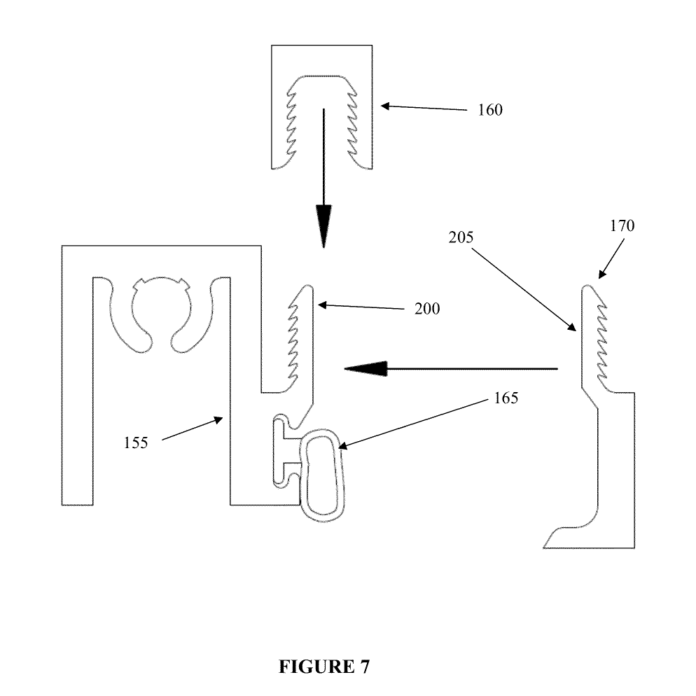

A close up view of an installed glazing anchorage system in accordance with embodiments of the present technology is illustrated in FIG. 5. The glazing anchorage system includes a glazing anchorage connector 155 which is fixedly connected to a glazing unit by a glazing coupling element 150. For example, the glazing coupling element can be a structural adhesive, silicone or other form of coupling element as would be known to a worker skilled in the art. The glazing anchorage system further includes a frame anchorage connector 170 which is fixedly connected to the frame of a structure by a frame connection element 151. For example, the frame connection element can be mechanical connector like a screw, rivet, bolt or the like. The glazing anchorage connector 155 and the frame anchorage connector are coupled together by an interconnector 160, which is configured to couple first and second elongated connection members formed in the glazing anchorage connector 155 and the frame anchorage connector 170. In some embodiments, the glazing anchorage system further includes a gasket system 165 configured to provide a seal between the glazing anchorage connector and the frame anchorage connector. FIGS. 6 and 7 provide an interconnected view and an exploded view of the glazing anchorage system, respectively, and more clearly illustrate the first elongated member 200 of the glazing anchorage connector and the second elongated member 205 of the frame anchorage connector.

According to embodiments of the present technology, the glazing mounting system can be used for replacement of failed sealed glazing units. The glazing mounting system according to the present technology can enable the silicone and sealed unit to be site applied rather than in a shop. The configuration of the instant glazing mounting system can allow for compression of a back gasket and holding of the glazing unit in place while the site grade silicone cures. As such, there is a reduced need for temporary clips to hold the unit in place as is currently done in the art, wherein these temporary clips would require later removal and a subsequent application of silicone for sealing at least the locations of clip removal.

### Glass Anchorage Connector

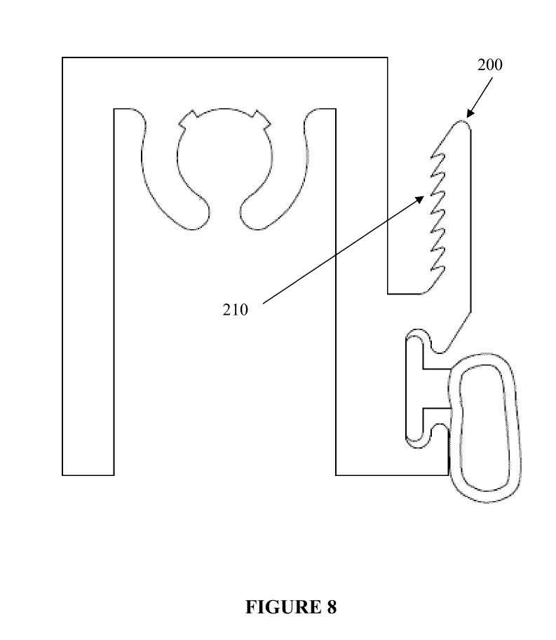

The glass anchorage connector is fixedly connected to the glazing unit and includes a first elongated member. According to some embodiments, the first elongated member includes one or more protrusions which can be configured to retain the interconnector in position upon its engagement with the glass anchorage connector. An example of a glass anchorage connector is illustrated in FIG. 8 with protrusions 210.

In some embodiments, the one or more protrusions can be configured as pyramidal protrusions, ridge type protrusions, saw tooth type protrusions or the like, for enhancement of the coupling with the interconnector. In some embodiments, the one or more protrusions formed in the glass anchorage connector are configured to mate with one or more protrusions which are formed on the interconnector and align therewith upon coupling of the glass anchorage connector with the interconnector. In some embodiments, the one or more protrusions are configured for ease of coupling of the glass anchorage connector and the interconnector but inhibit the removal of the interconnector upon coupling. For example, a protrusion with this functionality can be configured having a saw tooth or serrated configuration.

In some embodiments, the first elongated member is configured to have a desired level of surface friction on the face which is exposed to the interconnector, thereby providing a means for enhancing the interconnection there between. In some embodiments, coupling of the glass anchorage connector and the interconnector can be enhanced by an adhesive or other binding agent.

In some embodiments, the first elongated member can be configured as a finger type element, a triangular type element or the like, wherein the cross section of the first elongated member can be selected based on desired criteria including for example, interconnectivity between the glass anchorage connector and the interconnector, or the like.

The glass anchorage connector is fixedly connected to the glazing unit, wherein this connection can be provided by an adhesive, silicone or bonding agent designed to have a desired tensile strength such that the connection between the glazing unit and the glass anchorage connector can resist a desired loading. In some embodiments, this connection is provided by a structural glazing tape.

In some embodiments, the glass anchorage connector is formed as an extrusion, wherein the cross section thereof will be substantially uniform along the length of the extrusion. For example, the glass anchorage connector can be an extruded aluminum or other alloy, metal, plastic, uPVC or other material with sufficient structural properties to enable the desired interconnectivity for the glazing anchorage system.

In some embodiments, the glass anchorage connector further includes a gasket system which is configured for sealing engagement between the glass anchorage connector and the frame anchorage connector upon installation.

### Frame Anchorage Connector

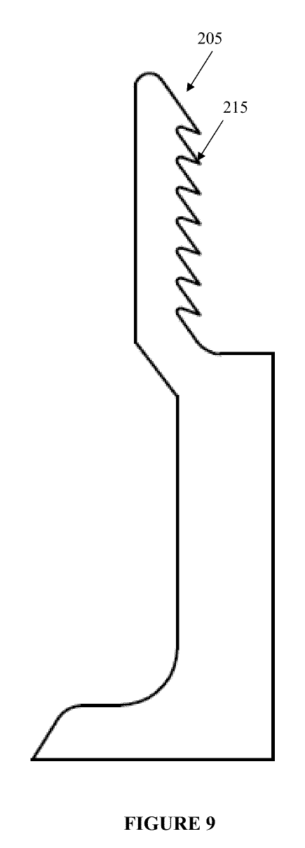

The frame anchorage connector is fixedly connected to the frame of a structure and includes a second elongated member. According to some embodiments, the second elongated member includes one or more protrusions which can be configured to retain the interconnector in position upon its engagement with the frame anchorage connector. An example of a frame anchorage connector is illustrated in FIG. 9 with protrusions 215.

In some embodiments, the one or more protrusions can be configured as pyramidal protrusions, ridge type protrusions, saw tooth type protrusions or the like, for enhancement of the coupling with the interconnector. In some embodiments, the one or more protrusions formed in the frame anchorage connector are configured to mate with one or more protrusions which are formed on the interconnector and align therewith upon coupling of the frame anchorage connector with the interconnector. In some embodiments, the one or more protrusions are configured for ease of coupling of the frame anchorage connector and the interconnector but inhibit the removal of the interconnector upon coupling. For example, a protrusion with this functionality can be configured having a saw tooth or serrated configuration.

In some embodiments, the second elongated member is configured to have a desired level of surface friction on the face which is exposed to the interconnector, thereby providing a means for enhancing the interconnection there between. In some embodiments, coupling of the frame anchorage connector and the interconnector can be enhanced by an adhesive or other binding agent.

In some embodiments, the second elongated member can be configured as a finger type element, a triangular type element or the like, wherein the cross section of the second elongated member can be selected based on desired criteria including for example, interconnectivity between the frame anchorage connector and the interconnector, or the like.

The frame anchorage connector is fixedly connected to the frame of the structure, wherein this connection can be provided by a connection device, for example a screw, bolt, nail or other connection device which alone or in combination with other connection devices is configured resist a desired loading.

In some embodiments, the frame anchorage connector is formed as an extrusion, wherein the cross section thereof will be substantially uniform along the length of the extrusion. For example, the frame anchorage connector can be an extruded aluminum or other alloy, metal, plastic, uPVC or other material with sufficient structural properties to enable the desired interconnectivity for the glazing anchorage system.

### Interconnector

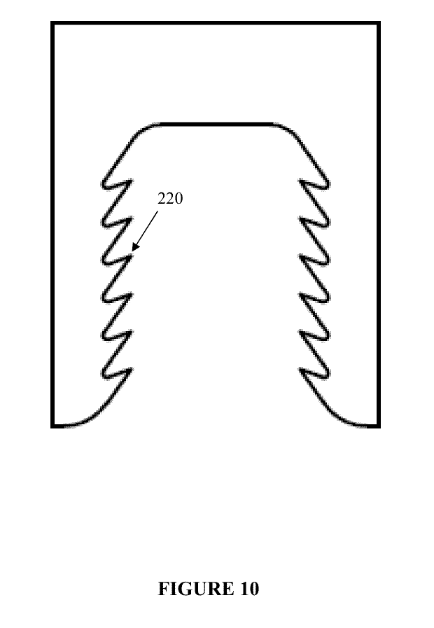

The interconnector is configured to couple the first elongated member of the glass anchorage connection with the second elongated member of the frame anchorage connector, thereby anchoring the glazing unit to the frame of the structure. According to some embodiments, the interconnector includes one or more protrusions which can be configured to retain the interconnector in position upon its engagement with the first elongated member and the second elongated member. An example of an interconnector is illustrated in FIG. 10 with protrusions 220.

In some embodiments, the one or more protrusions can be configured as pyramidal protrusions, ridge type protrusions, saw tooth type protrusions or the like, for enhancement of the coupling of the interconnector with the first elongated member, the second elongated or both. In some embodiments, the one or more protrusions formed in the interconnector are configured to mate with one or more protrusions which are formed on the first elongated member or the second elongated member or both. In some embodiments, the one or more protrusions are configured for ease of coupling of the interconnector with the first elongated member and the second elongated member, but inhibit the removal of the interconnector upon coupling. For example, a protrusion with this functionality can be configured having a saw tooth or serrated configuration.

In some embodiments, the interconnector is configured to have a desired level of surface friction on the face which is exposed to the first elongated member or the second elongated member or both, thereby providing a means for enhancing the interconnection there between. In some embodiments, coupling of the interconnector with the frame anchorage connector or the glass anchorage connector or both can be enhanced by an adhesive or other binding agent.

In some embodiments, the interconnector is configured as a channel, wherein the edges of the channel are configured to be positioned and engage with the first elongated member and the second elongated member. The channel can be a “U” shaped channel, a “C” shaped channel or other channel configuration as would be readily understood by a worker skilled in the art.

In some embodiments, the interconnector is formed as an extrusion, wherein the cross section thereof will be substantially uniform along the length of the extrusion. For example, the interconnector can be an extruded aluminum or other alloy, metal, plastic, uPVC or other material with sufficient structural properties to enable the desired interconnectivity for the glazing anchorage system.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A glazing anchorage system for interconnecting a glazing unit with a frame of a structure, the glazing anchorage system comprising:
a) a glass anchorage connector fixedly connected to the glazing unit, the glass anchorage connector including a first elongated connection member;
b) a frame anchorage connector fixedly connected to the frame of the structure, the frame anchorage connector including a second elongated connection member; and
c) an interconnector configured to couple the first elongated connection member and the second elongated connection member;
thereby anchoring the glazing unit to the frame of the structure.

2. The glazing anchorage system according to claim 1, wherein one or more of the glass anchorage connector, the frame anchorage connector and the interconnector are formed as elongated members.

3. The glazing anchorage system according to claim 2, wherein one or more of the glass anchorage connector, the frame anchorage connector and the interconnector are extrusions.

4. The glazing anchorage system according to claim 3, wherein one or more of the glass anchorage connector, the frame anchorage connector and the interconnector are formed from aluminium, metal, plastic or uPVC.

5. The glazing anchorage system according to claim 1, wherein the glass anchorage connector has first protrusions and the interconnector has second protrusions, wherein the first and second protrusions are configured to retain the interconnector in position upon coupling with the glass anchorage connector.

6. The glazing anchorage system according to claim 1, wherein the frame anchorage connector has first protrusions and the interconnector has second protrusions, wherein the first and second protrusions are configured to retain the interconnector in position upon coupling with the glass anchorage connector.

7. The glazing anchorage system according to claim 6, wherein the frame anchorage connector has third protrusions and the interconnector has fourth protrusions, wherein the third and fourth protrusions are configured to retain the interconnector in position upon coupling with the frame anchorage connector.

8. The glazing anchorage system according to claim 5, wherein the first protrusions or the second protrusions or both are pyramidal protrusions, ridge type protrusions or saw tooth type protrusions.

9. The glazing anchorage system according to claim 6, wherein the first protrusions or the second protrusions or both are pyramidal protrusions, ridge type protrusions or saw tooth type protrusions.

10. The glazing anchorage system according to claim 7, wherein one or more of the first protrusions, the second protrusions, the third protrusions and the fourth protrusion are pyramidal protrusions, ridge type protrusions or saw tooth type protrusions.

11. The glazing anchorage system according to claim 1, further comprising a gasket system configured to provide a seal between the glass anchorage connector and the frame anchorage connector.

12. The glazing anchorage system according to claim 1, wherein the first elongated member or the second elongated member or both are configured as a finger type element or a triangular type element.

13. The glazing anchorage system according to claim 1, wherein the first elongate member or the second elongate member has a level of surface friction on a face thereof exposed to the interconnector.

14. The glazing anchorage system according to claim 1, wherein the interconnector has a level of surface friction on a face exposed to the first elongate member or the second elongate member or both.

15. The glazing anchorage system according to claim 1, wherein the interconnector is configured as a channel.

16. The glazing anchorage system according to claim 15, wherein the interconnector is configured as a “U” shaped channel or a “V” shaped channel or a “C” shaped channel
